(19) United States
(12) Patent Application Publication
(10) Pub. No.: US 2023/0386713 A1
(43) Pub. Date: Nov. 30, 2023

(54) Superconducting Magnet Assembly and Associated Systems and Methods

(71) Applicant: Fermi Research Alliance, LLC, Batavia, IL (US)

(72) Inventor: Vladimir Kashikhin, Aurora, IL (US)

(21) Appl. No.: 18/203,988

(22) Filed: May 31, 2023

Related U.S. Application Data
(60) Provisional application No. 63/347,070, filed on May 31, 2022.

(51) Int. Cl. H01F 6/06; H01F 41/04

(52) U.S. Cl. CPC H01F 6/06; H01F 41/048

(57) ABSTRACT

A superconducting magnet system having a dipole magnet, a superconducting short-circuited secondary coil(s), a magnetizer, and a magnetizing primary coil. The dipole magnet comprises a magnet core having along its diameter a core back leg and a magnet gap. The High Temperature Superconducting (HTS) secondary coil(s) enwrap the core back leg of the dipole magnet. The magnetizer, positioned in magnetic communication with the dipole magnet, creates a closed magnetic circuit about the magnet gap. The non-superconducting magnetizing primary coil enwraps the magnetizer substantially opposite the secondary coil(s) with respect to the magnet gap. The magnetizing primary coil generates a common magnetic flux with the superconducting short-circuited secondary coil(s), initially operating in a non-superconducting state. Cooling the secondary coil(s) to a superconducting state transitions operation to frozen flux mode. After depowering the magnetizing primary coil, moving the magnetizer away from the magnet gap leaves the dipole magnet in persistent current mode.

### CROSS-REFERENCE TO RELATED APPLICATIONS

This application claims the benefit under 35 U.S.C. § 119(e) of U.S. Provisional Patent Application Ser. No. 63/347,070 titled SUPERCONDUCTING MAGNET ASSEMBLY AND ASSOCIATED SYSTEMS AND METHODS filed on May 31, 2022, the entire contents of which are incorporated herein by reference.

### STATEMENT REGARDING FEDERALLY SPONSORED RESEARCH OR DEVELOPMENT

The invention described in this patent application was made with Government support under the Fermi Research Alliance, LLC, Contract Number DE-AC02-07CH11359 awarded by the U.S. Department of Energy. The Government has certain rights in the invention.

### FIELD OF THE INVENTION

The present invention relates generally to superconducting magnet technology and, more particularly, to designs for superconducting magnetic systems working in a persistent current mode.

### BACKGROUND OF THE INVENTION

As a matter of definition, a “particle accelerator” is a machine configured to use electric or electromagnetic fields to propel subatomic charged particles (e.g., protons, electrons) to high velocities and energies, and to shape the particles into well-defined beams. Commonly in particle accelerator design, high magnetic fields may be applied to bend the particle beams and/or to focus the beams before a planned collision with other particles, for example, to research particle physics or to generate high-energy X-rays and gamma rays.

Superconducting materials are widely used in particle accelerators to create large continuous electric and magnetic fields for beam acceleration and manipulation. A “superconducting magnet,” as used herein, refers to an electromagnet featuring a superconducting coil made of a material that conducts electrical current without loss of energy due to electrical resistance and, therefore, produces a high magnetic field. Low Temperature Superconducting (LTS) materials include niobium-titanium (NbTi) and niobium-tin (Nb₃Sn). High Temperature Superconducting (HTS) materials include RE-Ba2Cu3O7-δ coated conductors (also referred to as Rare Earth, Barium-Copper-Oxide or REBCO) and Bi2Sr2CaCu2Ox (also referred to as Bi-2212). High magnetic field applications remain the focus of significant research, not only because HTS superconductors can produce much higher magnetic fields than the widely used LTS superconductors, but also because HTS magnet systems are more difficult to protect from quenches and high-current HTS cables are not readily available in the industry. Advantages of HTS magnet technology have been exploited for relatively low-field iron-dominated magnets that work at elevated temperatures up to 77 Kelvin (K).

Most superconducting magnet systems are powered by external power supplies. Some of these designs may operate in a persistent current mode (i.e., continuously generating magnetic field with a disconnected power source working like a permanent magnet). Recent advances in the state of superconducting magnet systems design, fabrication, and test include HTS magnets that work in a persistent current mode at a liquid nitrogen (LN₂) temperature and that generate a constant magnetic field in an iron-dominated magnet gap as induced from a primary coil. For example, certain magnet designs have been demonstrated to work during a short period of time in a current transformer mode using a primary copper coil to pump energy into a secondary, short-circuited HTS coil. Such designs allowed the decoupling of warm primary and superconducting secondary while also eliminating superconducting current leads, quench detection, protection systems, and a continuously engaged power supply.

HTS coils in certain designs of superconducting magnets have been assembled from the superconducting loops inductively coupled and energized by a primary coil. Most known HTS magnet coils are wound from tape-type superconductors or HTS cables. Because quench propagation in HTS is very slow, protecting such coils from local overheating is difficult. Also challenging is detecting a quench because, for the short length of HTS that is transferred in the normal condition, the voltage rise in this area is very low. An alternative way to make short-circuited HTS multi-turn coils is, as shown in FIG. 1, to employ a tape-type superconductor that has a slit in the middle 102, while still structurally intact at both ends 104. One implementation of this approach uses an assembly of short-circuited HTS loops that work in parallel. In such a configuration, the coil is self-protected against quenches because of current sharing induced by a mutual field and resistive coupling.

In summary, typical superconducting magnet systems designs comprise the following elements:
External large power supply
Expensive current leads
Long cables
Expensive quench detection and protection systems
Complicated instrumentation and control systems
Complicated cryostat and cooling systems

Known designs of superconducting magnets powered from an external power supply commonly present challenges, such as the following:
Superconductor quenches with a coil overheating
Current leads can be burned and provide large heat load for the cryogenic system
Even small damage to the superconductor can degrade magnet performance
HTS magnets are difficult to protect because of very slow quench propagation

Accordingly, a need exists for a solution to at least one of the aforementioned challenges in superconducting magnet design. For instance, an established need exists for improvements in the state of the art for economically and/or efficiently powering a superconducting magnetic system working in a persistent current mode.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to superconducting magnet systems configured to operate in persistent current mode as powered by a detachable magnetizer.

In certain embodiments of the present invention, a superconducting magnet system may operate in persistent current mode (e.g., continuously generate magnetic field with disconnected power source working like permanent magnet devices) based on direct mechanical energy transfer in the magnetic field. As employed in such a system, a short-circuited superconducting coil(s) do not have current leads and power source. Instead, a magnetizer magnetically coupled with the coil(s) (e.g., in an iron-dominated magnet system) may pump energy in the superconducting coil(s), as mechanical removal of the magnetizer from the magnet may induce a persistent current in the superconducting coil(s) which generates the magnetic field. Such superconducting magnet design may operate at elevated temperatures up to the liquid nitrogen temperature 77 Kelvin (K).

More specifically, a superconducting magnet system may comprise a dipole magnet, one or more superconducting short-circuited secondary coils, a magnetizer, and a magnetizing primary coil. In various embodiments, either or both of the dipole magnet and the magnetizer may be of a C-type configuration, and/or may comprise a ferromagnetic material (e.g., iron, low-carbon steel). The dipole magnet may include a magnet core characterized by a core back leg and a magnet gap. The core back leg may be positioned substantially opposite, along a diameter of the magnet core, the magnet gap. The superconducting short-circuited secondary coil(s) may comprise a High Temperature Superconducting (HTS) material and may be mounted circumferentially around the core back leg of the dipole magnet substantially proximate the magnet core diameter. In various embodiments, these secondary coil(s) may be implemented as parallel short-circuited loops. The magnetizer may be positioned in magnetic communication with the magnetic core of the dipole magnet (e.g., aligning a diameter of the magnetizer with the magnet core diameter to define a system diameter) to create a closed magnetic circuit about the magnet gap of the dipole magnet. The magnetizing primary coil may comprise a non-superconducting material and may be mounted circumferentially around the magnetizer substantially proximate the magnetizer diameter.

So configured, the magnetizing primary coil may generate along the closed magnetic circuit a common magnetic flux with the superconducting short-circuited secondary coil(s), which may be operating in a non-superconducting state. Cooling the superconducting short-circuited secondary coil(s) to a superconducting state may transition this secondary coil(s) to operation in frozen flux mode. The magnetizing primary coil may then be depowered, and the magnetizer may be detached from magnetic communication with the magnetic core of the dipole magnet. In certain embodiments, the magnetizer may detach from the magnet gap in a first detachment direction away from the magnet gap along the system diameter (i.e., horizontal detachment). In alternative embodiments, the magnetizer may detach from the magnet gap in a second detachment direction away from the magnet gap perpendicular to the system diameter (i.e., vertical detachment).

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a top view of a High Temperature Superconducting (HTS) coil assembled from parallel short-circuited loops as known in the prior art;

FIG. 2 is a perspective top view of a dipole magnet assembly according to an embodiment of the present invention;

FIG. 3 is a perspective top view of a superconducting magnet system according to an embodiment of the present invention;

FIG. 4 is a schematic of a common magnetic flux generated within the superconducting magnet system of FIG. 3;

FIG. 5 is a graph illustrating mechanical energy transfer efficiency for varying magnet gap fields deployed with a superconducting magnet system according to embodiments of the present invention;

FIG. 6 is a schematic view of the superconducting magnet system illustrated in FIG. 3 in a horizontal (X-axis) magnetizer displacement operation;

FIG. 7A is a graph illustrating superconducting coil current and gap field for the superconducting magnet assembly powered by the horizontal magnetizer displacement operation of FIG. 6;

FIG. 7B is a graph illustrating superconducting coil current and magnetizer separation force for the superconducting magnet assembly powered by the horizontal magnetizer displacement operation of FIG. 6;

FIGS. 8A, 8B, and 8C are schematic views of the superconducting magnet assembly illustrated in FIG. 3 in successive states of a vertical (Y-axis) magnetizer displacement operation;

and

FIG. 9A is a graph illustrating superconducting coil current and gap field for the superconducting magnet assembly powered by the vertical magnetizer displacement operation of FIGS. 8A, 8B, and 8C;

FIG. 9B is a graph illustrating superconducting coil current and magnetizer separation force for the superconducting magnet assembly powered by the vertical magnetizer displacement operation of FIGS. 8A, 8B, and 8C; and

FIG. 10 is a dimension-annotated front view of a magnet core of a dipole magnet assembly and a magnetizer according to an embodiment of the present invention.

Like reference numerals refer to like parts throughout the several views of the drawings.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

Certain embodiments of the superconducting magnet design of the present invention are now described in detail. Throughout this disclosure, the present invention may be referred to as a superconducting magnet system, a superconducting magnet assembly, a superconducting magnet, an electromagnet assembly, a magnet assembly, a magnet, an assembly, a device, a system, a product, and/or a method for energizing a superconducting magnet. Those skilled in the art will appreciate that this terminology is only illustrative and does not affect the scope of the invention. For instance, the present invention may just as easily relate to means to energizing a persistent current in various magnet designs.

In general, various embodiments of the present invention may employ mechanical energy transfer in short-circuited superconducting coils to generate the magnetic field in a magnet gap. A component of such a superconducting magnet system referred to hereinafter as a “magnetizer” may initially generate the common magnetic flux with a superconducting coil. After the common flux is established, the magnetizer may be mechanically displaced from the magnet system such that the mechanical energy used to open the closed magnetic circuit may be transferred in the useful magnetic field continuously supported by a persistent current generated in the superconducting coil. For example, and without limitation, magnets working in a persistent current mode may use superconducting switches. Certain embodiments of the systems and methods described herein for pumping mechanical energy in the magnetic field of dipole magnets may create mechanically energized magnets that advantageously may be used in various applications including, but not limited to, beam storage ring magnets, undulators, and electron-positron colliders employing magnetic fields below 1.5 Tesla (T).

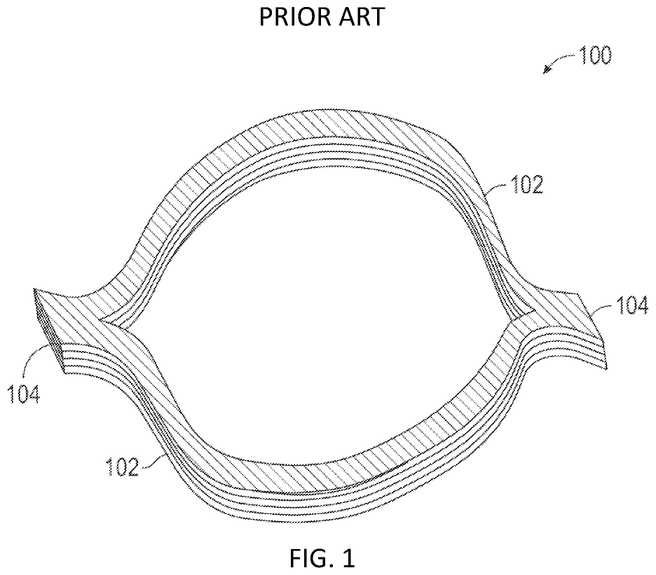

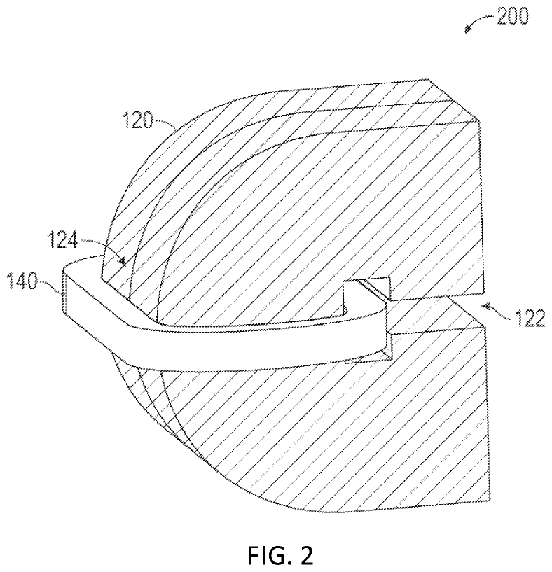

Referring initially to FIG. 2, an embodiment of a superconducting magnet system may comprise a dipole magnet 200 characterized by a main superconducting short-circuited coil 140 (also referred to as a secondary coil) coupled with a ferromagnetic core 120. As illustrated, the dipole magnet 200 may be of a C-type configuration and the ferromagnetic (e.g., iron) core 120 of the dipole magnet 200 may carry one or more HTS short-circuited secondary coils 140 mounted on a core back leg 124, as shown. Substantially co-diametrical and opposite the core back leg 124, the magnet core 120 further may present a magnet gap 122 within which a useful magnetic field may be generated. For example, and without limitation, the secondary coil 140 may comprise an H-type dipole HTS coil 100 assembled from multiple parallel short-circuited loops as shown in FIG. 1. Such a coil design may generate a very stable magnetic field for a relatively long period of time without field and current decay.

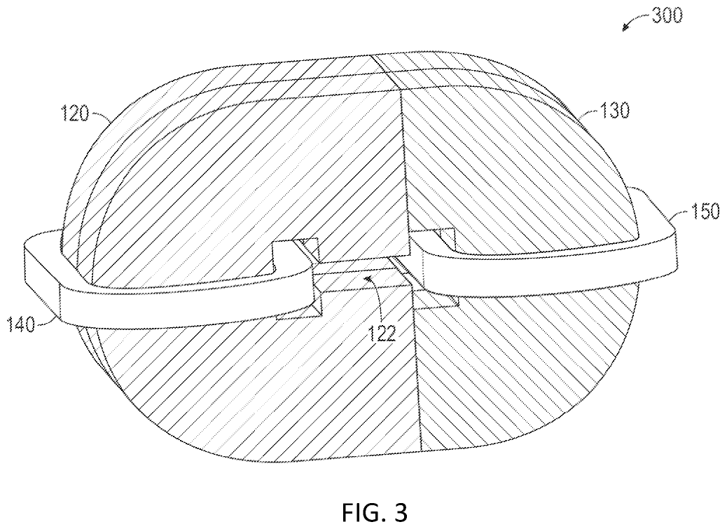

Referring now to FIG. 3, a superconducting magnet system 300 may comprise a detachable ferromagnetic part that may form a closed ferromagnetic circuit about the magnet core 120 of the dipole magnet 200 (as shown, a magnetizer 130 configured to position a powered, non-superconducting (e.g., copper (Cu)) magnetizing coil 150 or, alternatively, permanent magnets an operable distance from the secondary coil 140 to magnetize the closed circuit). As used hereinafter, the magnetizing coil 150 may also be referred to as a primary coil 150. The magnetizer 130 shown positioned proximate a gap side of the dipole magnet 200 may be characterized by a C-type configuration. For example, and without limitation, one or both of the dipole magnet core 120 and the magnetizer 130 may comprise low carbon steel.

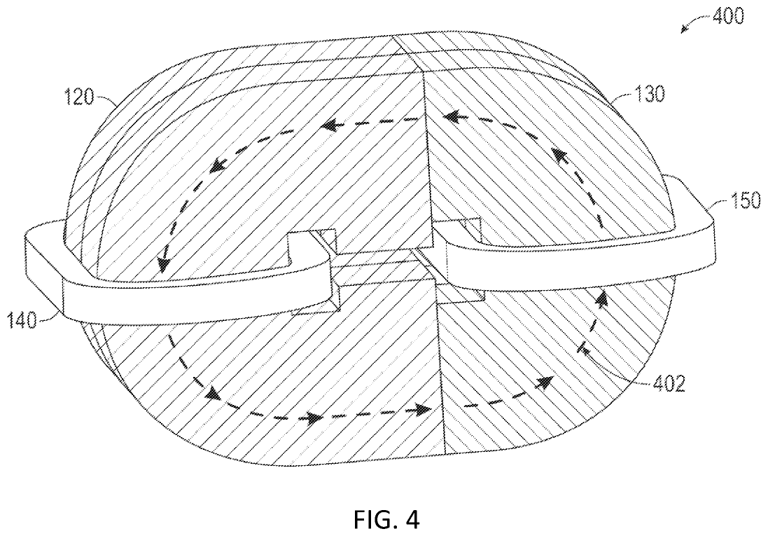

Initially, the secondary coil 140 may be in a non-superconducting state (also referred to as “warm” with no current), and the ferromagnetic circuit may be closed by the magnetizer 130. As illustrated in FIG. 4, the magnetizer 130 using a low current may generate a magnetic flux in the magnetic core 120 (more specifically, the primary coil 150 may produce a common magnetic flux 402 with the secondary coil 140). Positioned such that the magnetic core 120 and the magnetizer 130 forms a closed ferromagnetic loop without gaps, a very low total current for magnetization of this combined ferromagnetic core may be needed. The energy transfer process described hereinafter presumes material magnetic permeability which may be approximated by an analytic function μ(B).

From known simplified formulas, the magnet parameters' influence on the currents I, gap δ, gap field Bδ, and the proposed approach limitations may be determined. The magnetizer's total current Icu (1) for the closed magnetic circuit (e.g., common magnetic flux 402 of FIG. 4) and the superconducting dipole coil total current Isc (2) (e.g., HTS coil 100 of FIG. 1) may be defined as follows (per Equations (1) and (2)):

$$Icu = \frac{Bfe \cdot Lfe}{{μ}_{o} μ} \qquad ( 1 )$$

$$Isc = \frac{Bfe \cdot Lfe}{2 {μ}_{o} μ} + \frac{( B δ \cdot δ )}{{μ}_{o}} \qquad ( 2 )$$

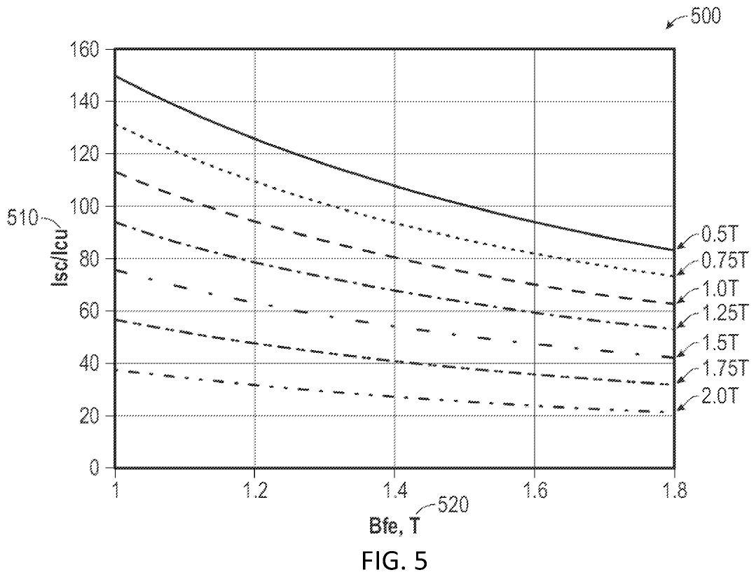

The magnetic flux may be presumed constant for both circuits, and the Lfe length of the flux path for the closed circuit in the iron yoke (e.g., core back leg 124) may be two times shorter than for the open one. The efficiency of stored in the magnetic field energy transfer may be as computed as in Equation (3):

$$Kef = \frac{Wsc}{Wcu} = \frac{Isc}{Icu} = \frac{1}{2} + \frac{μ ( Bfe ) \cdot B δ \cdot δ}{Bfe \cdot Lfe} , \qquad ( 3 )$$

where μ(Bfe) is the iron magnetic permeability approximation. At fixed magnet geometry, the efficiency of the superconducting current increase is proportional to the iron magnetic permeability and the magnet gap field (see comparison graph 500 at FIG. 5 for mechanical energy transfer efficiency 510 as a function of iron magnetic permeability 520 for the exemplary magnet gap 122 fields).

For example, and without limitation, graph 500 in FIG. 5 shows for 0.75 T magnetic field 402 in the 10 millimeter (mm) and 1.0 T in the iron the efficiency may be Kef=58. Therefore, the energy extracted from the magnetizing coil 150 may be 58 times lower than the mechanical energy that is transferred in the magnetic field. Increasing the magnet gap 122 two times may result in the energy transfer efficiency also increasing two times. Of course, the maximum energy transfer will be if all ferromagnetic material is removed from the superconducting coil 140 (i.e., air core magnet).

Proceeding from the non-superconducting state described hereinabove, the secondary coil 140 may be cooled down to the superconducting state (e.g., using an LN₂ bath). Applying this cooling may cause the secondary coil 140 to receive an induced current and start operating in a “frozen flux” mode in agreement with Lentz's Law, as the continuously circulating current in the superconducting secondary coil 140 may provide the magnetic flux constant condition (i.e., flux conservation law). More specifically, the secondary coil 140 total current may equal the previous total current of the magnetizer 130. At this point of operation, the current in the magnetizer 130 may be reduced to zero (that is, without current) and the magnetizer 130 may be disconnected from its power source.

As a matter of definition, a magnetizer may be used by an accelerator magnet to pump mechanical energy in a magnetic field. Certain types of magnetizers known in the art are referred to as lifters because these components may be used to lift and transport ferromagnetic pieces. Two general classes of lifters are electromagnets and permanent magnets. A permanent magnet lifter may feature a handle to rotate the permanent magnet block inside the lifter assembly to short-circuit the magnetic flux inside and eliminate the lifting force. In certain embodiments of the present invention, the permanent magnet lifter magnetic circuit may be designed to eliminate magnetic flux through the magnetizer 130 that is provided by the superconducting coil 150. Advanced lifter designs may combine both electromagnetic and permanent approaches but, for the separation, such designs may use a short capacitor bank discharge in the opposite direction to reduce the force needed for the separation. An exemplary embodiment of a C-type core magnetizer 130 with a copper primary coil 150 employed to pump the magnetic field energy in a dipole magnet 200 (as shown in FIGS. 2 and 3) may be characterized by parameters shown in Table I, as follows:

TABLE I
DIPOLE MAGNET DESIGN PARAMETERS

| Parameter | Unit | Magnetizer | HTS Dipole |
|---|---|---|---|
| Dipole magnet gap | Mm | — | 10 |
| Coils number of turns/loops | | 20 | 112 |
| Conductor | | Copper | HTS |
| Conductor dimensions | mm | 2 × 2 | 0.1 × 12* |
| HTS REBCO critical current | A | — | 93 |
| (6 mm wide), 77K, self-field | | | |
| Peak HTS coil current at 77K | A | — | 6000 |
| Peak field in the gap | T | — | 0.74 |
| Core length | mm | 64 | 64 |
| Outer yoke dimensions | mm | 90 × 120 | 105 × 120 |

*12 mm superconductor from SuperPower slit to form 6 mm wide loops.

Note that short-circuited superconducting coils also may be based on LTS NbTi or Nb3Sn superconductors having superconducting splices.

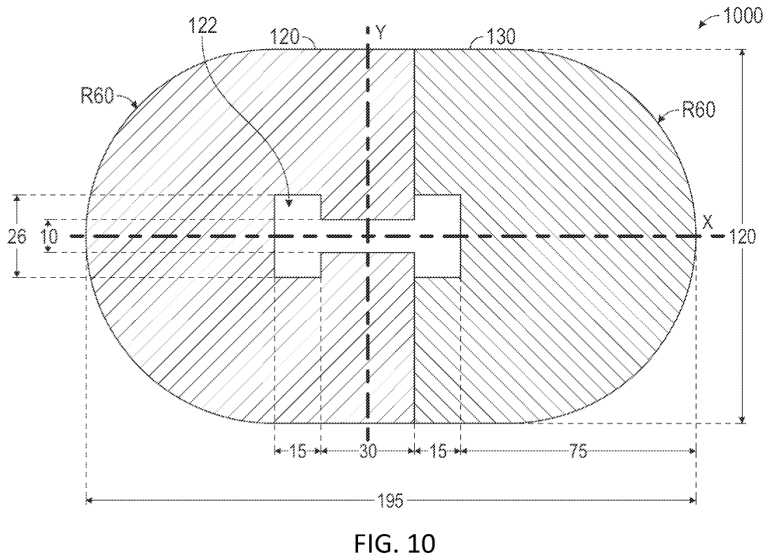

See also FIG. 10, illustrating a dimension-annotated assembly 1000 of a magnetic core 120 of a dipole magnet 200 positioned in magnetic communication with a magnetizer 130 (all measurements shown in millimeters (mm)). In this embodiment of the present invention, the assembly may present a conventional iron-dominated accelerator magnet configuration with a magnet gap 122 of 10 mm. The ferromagnetic portions of the magnetic core 120 and/or the magnetizer 130 may be assembled from 6.35 mm thick, low-carbon steel plates bolted in a longitudinal direction. Two HTS coils may be assembled from HTS loops 100 as shown in FIG. 1 and mounted around the core back leg 124 (see FIG. 2) of the dipole magnet 200 of such an assembly. Other applicable parameters of the assembly illustrated in FIG. 10 are shown in Table I above.

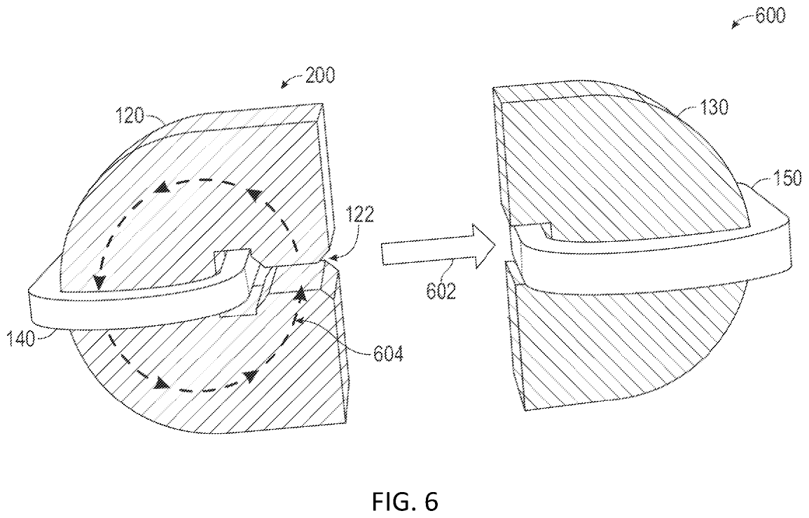

Referring now to FIG. 6, and continuing to refer to FIGS. 3 and 4, magnetizer 130 may be mechanically removed 602 from the dipole magnet 200. Strong magnetic forces may be needed to separate the superconducting 200 and non-superconducting 130, 150 assemblies. During this detachment process, all the used mechanical energy may be transferred through the redirected magnetic flux 402 in the dipole magnet 200 to the dipole magnet-stored energy 604 concentrated in the magnet gap 122. The substantially increased secondary coil 140 current continues to provide the magnetic flux constant condition, provided of course that superconducting coil 140 is capable to carry the induced current. Most of the mechanical energy may be used in the magnetizer 130 detachment process 602, as transferred and mostly concentrated in the magnet gap 122.

For example, and without limitation, the mechanical energy used to open the magnetic circuit horizontally (i.e., to move the magnetizer 130 away from the dipole magnet 200 collinearly with their respective diameters), against magnetic forces, may be transferred in the superconducting secondary coil 140 current and the magnetic field 604 in the magnet gap 122. The “frozen flux” mode means that, in agreement with Lentz's Law in the short-circuited superconducting secondary coil 140, induced currents tend to keep the connection with coil magnetic flux constant (i.e., frozen). Moving the magnetizer 130 away from the dipole magnet 120 (as shown, in a horizontal or X-axis direction 602) may induce the large secondary coil 140 current to provide the same flux as was “frozen.” The mechanical energy used to open the closed magnetic circuit may be transferred in the useful magnetic field 604 concentrated in the magnet gap 122 continuously supported by a persistent current generated in the superconducting secondary coil 140.

Lenz's law states that “the current induced in a circuit due to a change in a magnetic field is directed to oppose the change in flux and to exert a mechanical force which opposes the motion.” An exemplary implementation of such a useful magnetic field generation as described above for a secondary coil 140 (denoted “sc”) and a magnetizing coil 150 (denoted “cu”) separated using mechanical energy (denoted “mech”) is shown in the following Equation (4):

Ψ=L*I=Const

L_{sc}*I_{sc}=L_{cu}*I_{cu}

L_{sc}(low)*I_{sc}(high)=L_{cu}(high)*I_{cu}(low) (4)

Exemplary values for stored energy W, in joules (J), are shown in the following Equation (5):

W_{sc}=W_{cu}+W_{mech}=0.12+12.6=12.7 J (5)

In the above example, stored energy increased 108 times, and only 0.9% of energy originates from the magnetizer 130.

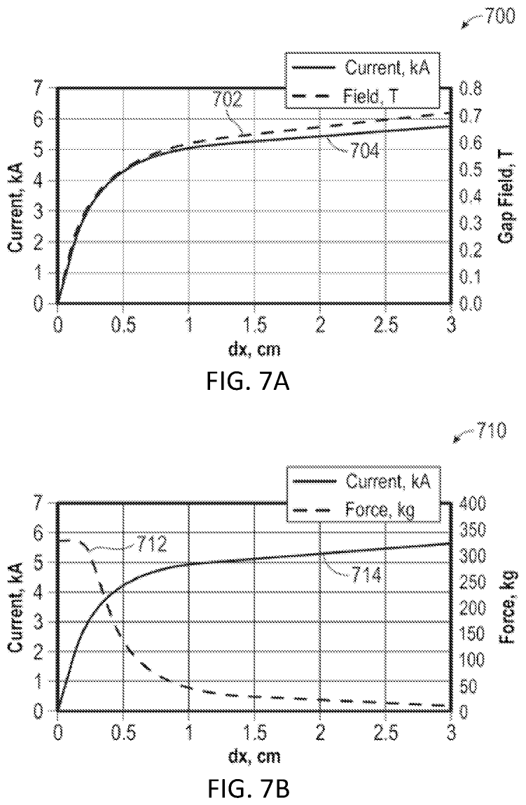

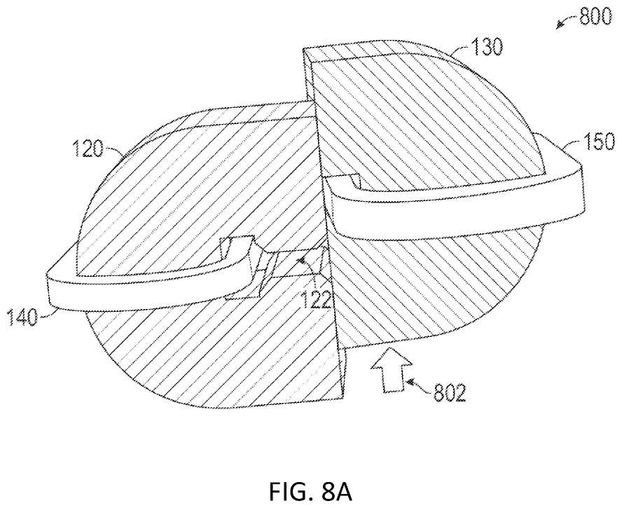

FIGS. 7A and 7B illustrate that the gap field follows the induced current in the superconducting loop (i.e., secondary coil 140). But the larger distance, dx, experiences the lower effect of separation. For example, and without limitation, the peak force initially needed to separate the dipole magnet 200 and the magnetizer 130 is 330 kg (see graph 710 of FIG. 7B), which exponentially decays with the separation distance. This value agrees with the magnetic Maxwell pressure estimation of Equation (6) for a 1.16 T average field on separated surfaces, as follows:

$$F x = {\int }_{S} \frac{{B}^{2}}{2 {μ}_{0}} \cdot dS . \qquad ( 6 )$$

Still referring to FIGS. 7A and 7B, and referring additionally to FIG. 6, for the powering scenario involving moving magnetizer 130 horizontally (that is, in an X-axis direction along these components' shared diameter) away from dipole magnet 200, graphs 700 and 710 show the peak magnetizer moving force 712 is only 325 kilograms (kg) to generate a 0.7 Tesla (T) field 702 in the gap. The peak current in secondary coil 140 is 6 kiloampere (kA) at magnetizer 150 current 106 ampere (A), with the current increase coefficient K=57.

In certain embodiments of the present invention, another option for mechanical transfer is to move the magnetizer 130 perpendicularly, rather than collinearly, with respect to the diameter of the superconducting magnet system 200 as assembled in a pre-detachment state. Before such detachment (also referred to as “vertical” and/or “Y-axis” detachment), the magnetizer coil 150 current may be presumed to be transferred in the superconducting secondary coil 140 and the magnetizing coil 150 may be presumed to have a zero current, as in the pre-detachment state described above for horizontal detachment.

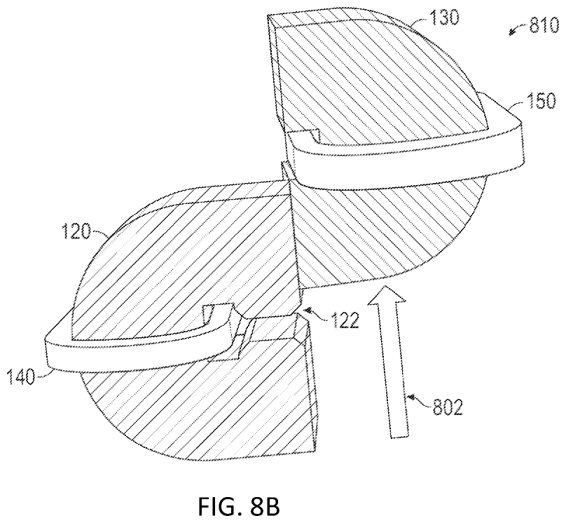

Referring to FIGS. 8A, 8B, and 8C, the superconducting magnet system 300 of FIG. 3 may be operated 800, 810, 820 such that detachable magnetizer 130 may be displaced vertically (that is, in a Y-axis direction perpendicular to the dipole magnet's 200 diameter) such that the resultant displacement 802 creates a desired gap in the closed magnetic circuit.

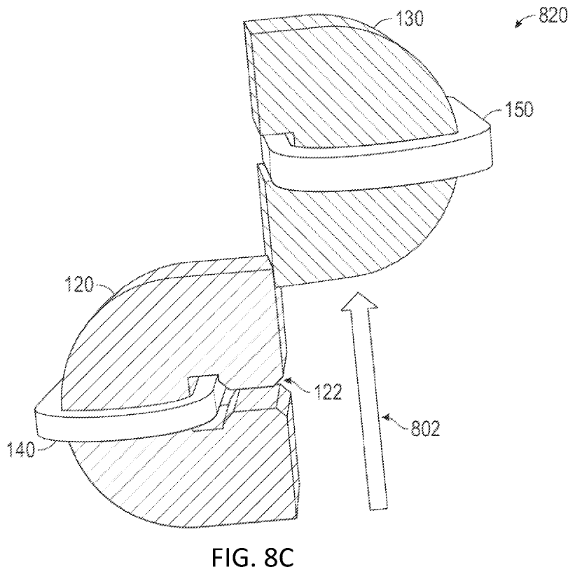

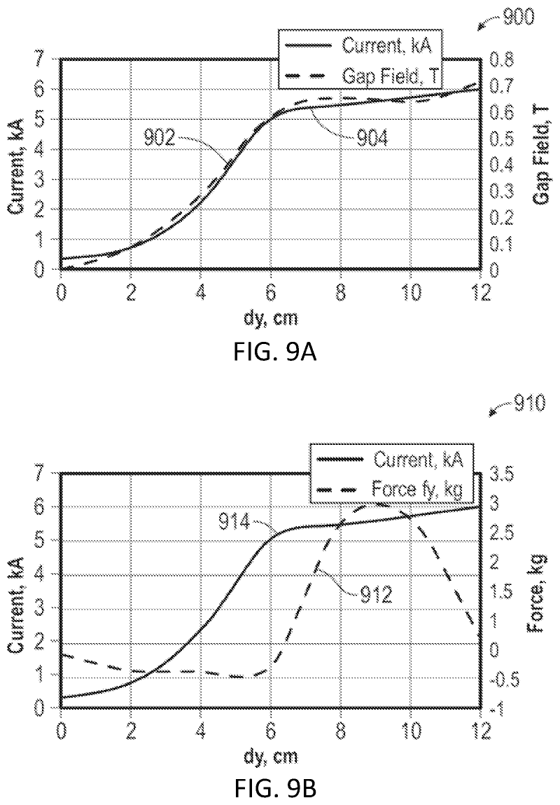

The vertical magnetizer movement 800, 810, 820 may have a lower current and gap field variation than the horizontal magnetizer movement 600, as shown in graphs 900 and 910 of FIGS. 9A and 9B. But the total energy transfer may be substantially equal to the energy transferred at the horizontal magnetizer movement 600. For example, and without limitation, for the powering scenario involving moving magnetizer 130 vertically (that is, in Y), graphs 900 and 910 show the peak magnetizer moving force 914 is approximately 3 kg to generate 0.7 T field in the gap. Therefore, the vertical displacement of FIGS. 8A, 8B, and 8C as shown is more efficient than the horizontal displacement of FIG. 6. In this case, the gap field and induced current have lower variation with separation distance. Graph 910 at FIG. 9B shows the current and the separation force variation. An advantage of the vertical magnetizer moving 800, 810, 820 is that the required peak separation force may be a hundred times lower than for the horizontal magnetizer movement 600 at the same value of mechanical energy transfer.

As described above, relatively low magnetic-field HTS magnets may advantageously replace conventional, room-temperature electromagnets or permanent magnets for certain applications. The reduced operational power losses in HTS magnets may come from the superconductivity by using cryogenics. A model of an embodiment of the HTS dipole magnet as described hereinabove may comprise as a room-temperature magnet with a water-cooled copper coil. The magnet may have a 10 mm gap, and the peak field in the gap may be 0.7 T. A coil with a total current of 5.6 kA may be needed for this field. The optimal current density for these types of magnets may be 4 A/mm². In this exemplary model, the copper cross-section may be 1400 mm². The coil power dissipation may be 0.9 kW for the 1 m magnet length. Assuming an average cost of electricity as $0.12 S/kWh, the operational cost of this magnet model may be 0.11 $/h or 964 $/year. The liquid nitrogen production cost may be 0.18 $/liter. Therefore, the HTS magnet cryostat evaporation rate should be 0.6 l/h to make even operational costs. The preliminary estimated the LN₂ evaporation rate may be 0.04 l/h which is much less than 0.6 l/h. Not included in this calculation are the room-temperature magnet costs of power supply, cabling, water cooling systems, protection, and monitoring systems. In summary, as shown in embodiments hereinabove, magnetizer displacement may open a closed magnetic circuit and pump mechanical energy in the magnetic field energy inducing huge current in a superconducting coil. A relatively small part of required energy is used in the magnetizer (that is, the mechanical energy of hydraulic or other mechanical systems by which the magnetizer is moved). In various embodiments of the present invention, the magnetizer is used only once for advantageous energy pumping and, therefore, may be used again later for other magnets. Also, because the magnetizer coil operates a short period of time, this energizing coil may be made from the copper material, which may advantageously reduce total superconducting magnet design cost as HTS materials are comparatively expensive. Once energized, the superconducting magnet works in a persistent current mode without power source, current leads, and magnetizer. That is, the present invention employs a direct one-time mechanical energy transfer to the permanently generated magnetic field without power source.

The invention described hereinabove may use a magnetizer to convert mechanical energy in the superconducting coil current and the magnet gap field. Because of the initially magnetically closed circuit, only 0.9% of energy need be extracted from the magnetizer coil and/or permanent magnets than in a conventional magnet to generate the gap field. The vast majority (99.1%) of the resultant magnetic field energy is obtained from the mechanical energy of the displaced magnetizer. Such a superconducting magnet system may be applied in particle accelerators, solenoids and various standalone magnets, and electrical machines.

Proposed system advantages include the following:
No power supply for the superconducting coil
No current leads and cables for each magnet
No quench detection, protection, control systems
Simple cryostat just around the coil
Cheap magnetizer could be based on the commercial magnetic lifters

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced items.

Thus, the scope of the invention should be determined by the appended claims and their legal equivalents, and not by the examples given.

That which is claimed is:

1. A superconducting magnet system comprising:
a dipole magnet comprising a magnet core characterized by a core back leg positioned substantially opposite a magnet gap along a first diameter of the magnet core,
at least one superconducting short-circuited secondary coil mounted circumferentially around the core back leg of the dipole magnet substantially proximate the first diameter of the magnet core,
a magnetizer configured in magnetic communication with the magnetic core of the dipole magnet, to define a closed magnetic circuit about the magnet gap of the dipole magnet, and
a magnetizing primary coil mounted circumferentially around the magnetizer substantially proximate a second diameter of the magnetizer;
wherein the magnetizing primary coil is configured to generate along the closed magnetic circuit a common magnetic flux with the at least one superconducting short-circuited secondary coil operating in a non-superconducting state;
wherein the at least one superconducting short-circuited secondary coil is configured to, upon cooling to a superconducting state, transition to operating in a frozen flux mode; and
wherein the magnetizer is configured to, upon depowering of the magnetizing primary coil, detach from the magnetic communication with the magnetic core of the dipole magnet.

2. The superconducting magnet system according to claim 1 wherein at least one of the dipole magnet and the magnetizer is of a C-type configuration.

3. The superconducting magnet system according to claim 1 wherein at least one of the dipole magnet and the magnetizer is of a ferromagnetic material type.

4. The superconducting magnet system according to claim 3 wherein at least one of the magnetizer and of the magnet core of the dipole magnet comprises low-carbon steel.

5. The superconducting magnet system according to claim 1 wherein the at least one superconducting short-circuited secondary coil is of a High Temperature Superconducting (HTS) material type.

6. The superconducting magnet system according to claim 5 wherein the at least one superconducting short-circuited secondary coil comprises a plurality of parallel short-circuited loops.

7. The superconducting magnet system according to claim 1 wherein the magnetizing primary coil is of a non-superconducting material type.

8. A method of manufacturing a superconducting magnet system comprising:
a dipole magnet comprising a magnet core characterized by a core back leg positioned substantially opposite a magnet gap along a first diameter of the magnet core,
at least one superconducting short-circuited secondary coil,
a magnetizer, and
a magnetizing primary coil;
the method comprising the steps of:
mounting the at least one superconducting short-circuited secondary coil circumferentially around the core back leg of the dipole magnet substantially proximate the first diameter of the magnet core;
mounting the magnetizing primary coil circumferentially around the magnetizer substantially proximate a second diameter of the magnetizer;
detachably mounting the magnetizer in magnetic communication with the magnetic core of the dipole magnet along a system diameter colinear with the first diameter of the magnet core and the second diameter of the magnetizer, to define a closed magnetic circuit about the magnet gap of the dipole magnet operable to electrically loop a common magnetic flux between the magnetizing primary coil and the at least one superconducting short-circuited secondary coil.

9. The method of manufacturing the superconducting magnet system according to claim 8, further comprising:
configuring the magnetizing primary coil to generate along the closed magnetic circuit a common magnetic flux with the at least one superconducting short-circuited secondary coil operating in a non-superconducting state;
configuring the at least one superconducting short-circuited secondary coil to, upon cooling to a superconducting state, transition to operating in a frozen flux mode; and
configuring the magnetizer to, upon depowering of the magnetizing primary coil, detach from the magnetic communication with the magnetic core of the dipole magnet.

10. The method of manufacturing the superconducting magnet system according to claim 9, wherein the configuring the magnetizer to detach further comprises at least one of:
configuring the magnetizer to detach from the magnet gap in a first detachment direction along the system diameter; and
configuring the magnetizer to detach from the magnet gap in a second detachment direction perpendicular to the system diameter.

11. The method of manufacturing the superconducting magnet system according to claim 8, wherein at least one of the dipole magnet and the magnetizer is of a C-type configuration.

12. The method of manufacturing the superconducting magnet system according to claim 8, wherein at least one of the dipole magnet and the magnetizer is of a ferromagnetic material type.

13. The method of manufacturing the superconducting magnet system according to claim 8, wherein the at least one superconducting short-circuited secondary coil is of a High Temperature Superconducting (HTS) material type.

14. The method of manufacturing the superconducting magnet system according to claim 8, wherein the magnetizing primary coil is of a non-superconducting material type.

15. A method of operating a superconducting magnet system comprising:
a dipole magnet comprising a magnet core characterized by a core back leg positioned substantially opposite a magnet gap along a first diameter of the magnet core,
at least one superconducting short-circuited secondary coil mounted around the core back leg of the dipole magnet substantially proximate the first diameter of the magnet core,
a magnetizer, and
a magnetizing primary coil mounted around the magnetizer substantially proximate a second diameter of the magnetizer;
the method comprising the steps of:
detachably mounting the magnetizer in magnetic communication with the magnetic core of the dipole magnet along a system diameter colinear with the first diameter of magnet core and the second diameter of the magnetizer, to define a closed magnetic circuit about the magnet gap of the dipole magnet;
generating, using the magnetizing primary coil, a common magnetic flux along the closed magnetic circuit with the at least one superconducting short-circuited secondary coil operating in a non-superconducting state;
cooling the at least one superconducting short-circuited secondary coil to a superconducting state;
depowering, upon the at least one superconducting short-circuited secondary coil transitioning to a frozen flux operation mode, the magnetizing primary coil; and
detaching the magnetizer from the magnetic communication with the magnetic core of the dipole magnet.

16. The method of operating the superconducting magnet system according to claim 15 wherein the detaching the magnetizer further comprises detaching the magnetizer from the magnet gap in a first detachment direction along the system diameter.

17. The method of operating the superconducting magnet system according to claim 15 wherein the detaching the magnetizer further comprises detaching the magnetizer from the magnet gap in a second detachment direction perpendicular to the system diameter.

18. The method of operating the superconducting magnet system according to claim 15 wherein at least one of the dipole magnet and the magnetizer is of a ferromagnetic material type.

19. The method of operating the superconducting magnet system according to claim 15 wherein the at least one superconducting short-circuited secondary coil is of a High Temperature Superconducting (HTS) material type.

20. The method of operating the superconducting magnet system according to claim 15 wherein the magnetizing primary coil is of a non-superconducting material type.
